(19) United States
(12) Patent Application Publication
(10) Pub. No.: US 2010/0002782 A1
(43) Pub. Date: Jan. 7, 2010

(54) RADIO COMMUNICATION SYSTEM AND RADIO COMMUNICATION METHOD

(76) Inventors: Yutaka Asanuma, Tokyo (JP); Shigeo Terabe, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/166,365

(22) Filed: Jul. 2, 2008

(51) Int. Cl. H04K 1/10

(52) U.S. Cl. 375/260

(57) ABSTRACT

In an OFDM cellular system, a power density of a phase reference signal of a time frame used in an initial synchronization process (time frame including a system information notification signal, or a time frame in the vicinity thereof), in a channel band for initial synchronization, is more increased than that of the other time frame.

### BACKGROUND OF THE INVENTION

1. Field of the Invention

The present invention relates to a radio communication system employing OFDM (Orthogonal Frequency Division Multiplexing).

2. Description of the Related Art

Currently, in 3GPP (3^{rd} Generation Partnership Project), Long Term Evolution (LTE) concerning new radio accesses and radio access networks, succeeding W-CDMA (Wideband Code Division Multiple Access), has been reviewed (cf., 3GPP, TR25.814 (V7.1.0), “Physical Layer Aspects for Evolved UTRA”, Section 7.1.2.4, “Cell search”). This document is a technical document released by 3GPP, describing the framework of standards concerning physical layers.

An initial synchronization process described therein is a procedure by which a mobile station establishes time and frequency synchronization with a base station and detects an identification number of the base station on the basis of a signal received from the base station.

In the LTE system, Scalable Bandwidth is applied to support a plurality of different system bands. In the initial synchronization process of the LTE system, the system bands of the base station are unknown for the mobile station. To detect the system bands of the base station and execute processes corresponding to the respective system bands, a complicated search process is required for the mobile station.

On the other hand, to simplify the search process of the system bands, locating a channel for synchronization, and a channel to notify the system information, in a minimum system band common to the base station employing all the system bands, and transmitting the channel for synchronization and the system information notification channel from the base station to the mobile station have been conceived. The mobile station can thereby execute the initial synchronization process by receiving the channel for synchronization located in the predetermined common minimum system band and the system information notification channel, without obtaining information on the system bands of the base station.

In the LTE system which is now considered, however, the power density of the phase reference signal is fixed from the viewpoint of maximizing the system throughput, and the method of locating the phase reference signal of the time symbol-frequency band by which the channel for synchronization and the system information notification channel are located is not considered. For this reason, three problems stated below may occur.

1) From the viewpoint of using the phase reference signal for the synchronization process, since the power density is insufficient, a period for detection of the identification of the base station by using the phase reference signal as one of the synchronization processes becomes long.

2) From the viewpoint of using the phase reference signal for synchronous detection of the system information notification channel, the frequency synchronization between the mobile station and the base station is generally insufficient while the mobile station is in the initial synchronization process. In addition, the improvement of the signal power of the phase reference signal caused by averaging some phase reference signals that are proximate in time and frequency is limited. The transmission path estimation accuracy of the system information notification channel cannot be thereby assured sufficiently, and the demodulation performance is deteriorated.

3) When the frequency shift of the phase reference signal is applied to each base station, for the purpose of reducing the interference of the phase reference signal the frequency location of the phase reference signal is not determined unless the mobile station is preliminarily notified of the shift amount, in the initial synchronization process. Therefore, the extraction of the phase reference signal cannot be executed.

In the conventional radio communication system, problems are raised in terms of the detection period of the phase reference signal, the demodulation performance, and the process stability, in the initial synchronization process of establishing the time and frequency synchronization with the transmitter (for example, base station) on the basis of the signal received from the transmitter by the receiver (for example, mobile station) and detecting the identification number of the transmitter.

### BRIEF SUMMARY OF THE INVENTION

The present invention has been accomplished to solve the above-described problems. The object of the present invention is to provide a radio communication system and radio communication method capable of reducing the detection period of the phase reference signal, and enhancing the demodulation performance and the process stability, in the initial synchronization process executed by the receiver on the basis of the signal receive from the transmitter.

To achieve this object, an aspect of the present invention is an OFDM radio communication system comprising a plurality of transmitters transmitting OFDM signals and a receiver receiving the OFDM signals. Each of the transmitters comprises a transmitting unit which, of a preset first frequency band common to the plurality of transmitters and a second frequency band other than the first frequency band, allocates a phase reference signal in the first frequency band, at a higher power density than that in the second frequency band, and transmits the OFDM signal to which a control signal including system information that needs to be received prior to starting the transmission. The receiver comprises a receiving unit which receives the OFDM signal transmitted from the transmitter, and a demodulating unit which executes channel equivalence of the control signal and demodulates the control signal, in accordance with the phase reference signal received in the first frequency band by the receiving unit.

As described above, in the present invention, the transmitter allocates the phase reference signal in the first frequency band, at a higher power density than that in the second frequency band, of the first frequency band preset commonly to a plurality of transmitters and the second frequency band other than the first frequency band, and transmits the phase reference signal. The receiver executes channel equivalence of the control signal and demodulates the control signal, in accordance with the phase reference signal received in the first frequency band by the receiving unit.

Therefore, since the receiver according to the present invention receives the first frequency band common to a plurality of transmitters and executes channel equivalence of the control signal on the basis of the phase reference signal included at high power density, the present invention can provide a radio communication system and radio communication method capable of reducing the detection period of the phase reference signal, and enhancing the demodulation performance and the process stability, in the initial synchronization process executed by the receiver on the basis of the signal receive from the transmitter.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing an OFDM transmission format employed in a radio communication system according to the present invention;

FIG. 2 is a flowchart showing an initial synchronization process of a receiving side of the radio communication system according to the present invention;

FIG. 3 is a block diagram showing a configuration of a transmitting side of the radio communication system according to the present invention;

FIG. 4 is a block diagram showing a configuration of a receiving side of the radio communication system according to the present invention;

FIG. 5 is an illustration showing an OFDM transmission format employed in a radio communication system according to the present invention; and

FIG. 6 is an illustration showing an OFDM transmission format employed in a radio communication system according to the present invention.

### DETAILED DESCRIPTION OF THE INVENTION

An OFDM cellular system according to an embodiment of the present invention is described below with reference to the accompanying drawings. In the following descriptions, the transmitting side is a base station while the receiving side is a mobile station.

First, a transmission format for the transmission from the base station to the mobile station in the OFDM cellular system according to the present invention is described. A plurality of base stations provided in the OFDM cellular system use system bands of different bandwidths (i.e. bandwidths in which the respective base stations can allocate transmission signals), respectively. A band common to the system bands is used for the initial synchronization process as a channel band for initial synchronization.

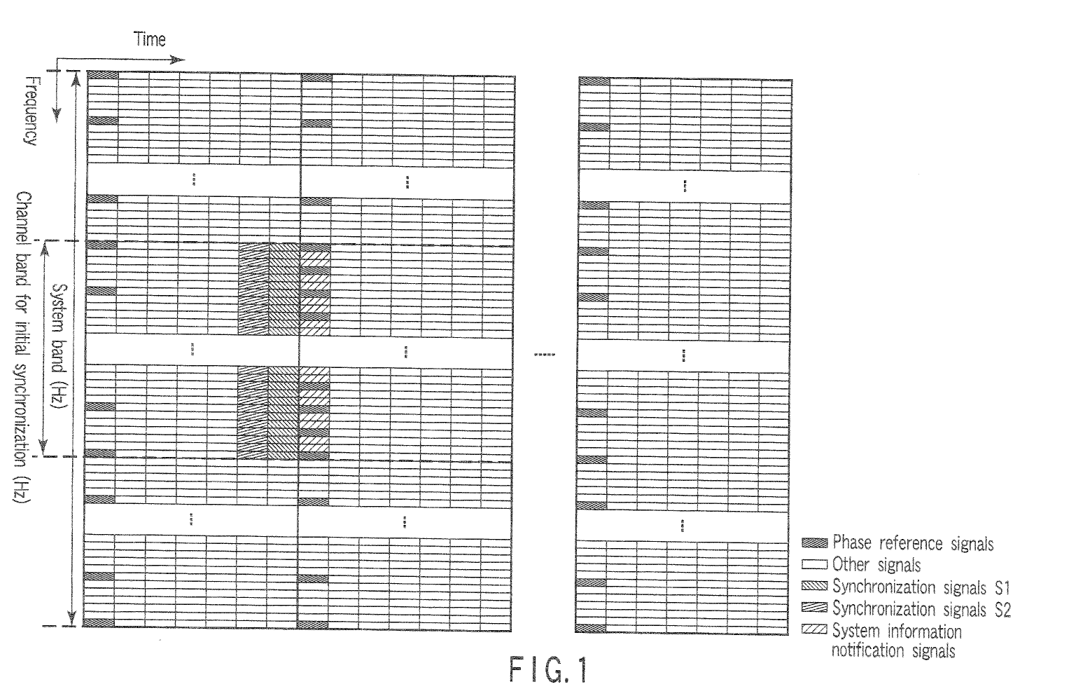

FIG. 1 shows the channel band for initial synchronization and the bands in the vicinity of the channel band. FIG. 1 shows a transmission format in which a frequency density of a phase reference signal in a time frame including system information notification signals or a time frame in the vicinity of the time frame including the system information notification signals, in the channel band for initial synchronization, is compared with phase reference signals in other time frames, and the double frequency density is allocated.

The frequency band which varies the phase reference signals at a high density (high rate) is thus limited for the following reason. In the cellular system (Scalable Bandwidth) for supporting the base stations having different system bandwidths, respectively, the system bandwidth of the base station is unknown for the mobile station in the initial synchronization process. For this reason, the mobile station can achieve a stable synchronization performance and carry out the initial synchronization process without preliminarily recognizing the system band of the base station by executing a process (Process C to be described later) using the only phase reference signal located in the channel band used for the initial synchronization, i.e. the minimum system bandwidth (channel band for initial synchronization). The searching of the initial synchronization process can be thereby simplified.

In addition, the reason for limiting the time symbol which varies the phase reference signals to be of high density (high rate) is as follows. Increasing the power density of the phase reference signals in all the time frames allows cumulative addition in the time direction and may consequently cause the reduction of the synchronization time. By increasing the power density, however, the signaling overhead of the phase reference signal is increased and the deterioration of the system throughput is caused, and disadvantages are thereby caused for the entire system. Therefore, by limiting the time frame to which Process C is applied and increasing the power density of the phase reference signals, for example, the received RF is stopped outside the time frame and the power consumption of the mobile station can be reduced.

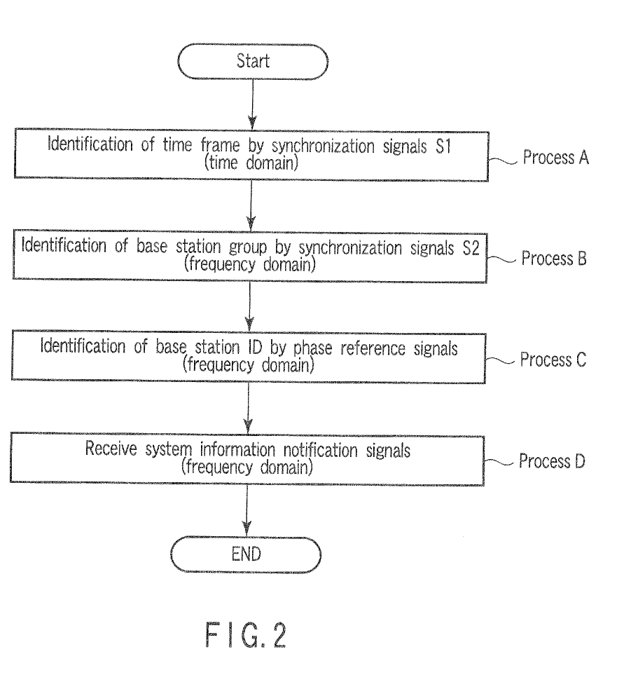

Next, the initial synchronization process at the mobile station is explained. As shown in FIG. 2, the mobile station has four processes A, B, C and D as the initial synchronization process. The Process A processes the time-domain signals and the Processes B to D process the frequency-domain signals. Prior to these processes, the received signal is down-converted and sampled to obtain the baseband digital signal.

The Process A is a process of finding the time frame boundary of the baseband digital signal, i.e. the timing of extracting the sampling data sequence for executing the GI removal and FFT operation, by obtaining cross-correlation between the baseband digital signal including synchronization signal S1 at a predetermined timing and the known code included in the synchronization signals S1. As such a synchronization code used for the frame synchronization, a synchronization code having a repeated waveform in a time domain car be used besides the above synchronization code. When this synchronization code is used, the frame boundary is found by the autocorrelation.

Each of the Processes B and C multiplies the sampling date sequence of the baseband digital signals by FFT (Fast Fourier Transform) by the time frame unit obtained by the Process A, divides the sampling date sequence into the frequency-domain signals, i.e. the signals for the respective sub-carriers as shown in FIG. 1, and identifies the base station ID on the basis of the information on the frequency domain thereby obtained.

To reduce the time to be spent for identification of the base station ID in the cellular system, generally, the group to which the base station belongs is identified in the Process B while the base station ID is specified from the group of the base station obtained in the Process B. The base station ID is thus identified in two steps.

Synchronization signals S2 are used in the Process B while the phase reference signals used for channel equivalence of the data signals or measurement of the received signals from the respective base stations are used in the Process C. Scrambling codes inherent to the base stations are applied to the phase reference signals to measure the reduction in interference between the signals transmitted from the base stations and the receiving powers from the base stations. Therefore, the base station can identify the base station ID by specifying the scrambling code.

In the Process D, the system information notification signals including the information such as a parameter which is necessary for reception of the data signal, and the like, are received. The phase reference signals are used for the channel equivalence of the system information notification signals.

The process of obtaining the basic system parameter required for the communications before reception of the data signal, by the Processes A to D is called the initial synchronization process. Of the Processes A to D, location of the phase reference signals is related with the Process C and the Process D. In the present invention, the time required for detection of the base station ID in the Process C can be reduced and the receiving performance of the system information notification signal in the Process D can be enhanced, by locating the phase reference signals as shown in FIG. 1. For this reason, since the time required for the initial synchronization process can be reduced, the power consumption at the mobile station can be reduced.

Configurations of the base station and the mobile station for the above-explained OFDM cellular system are described.

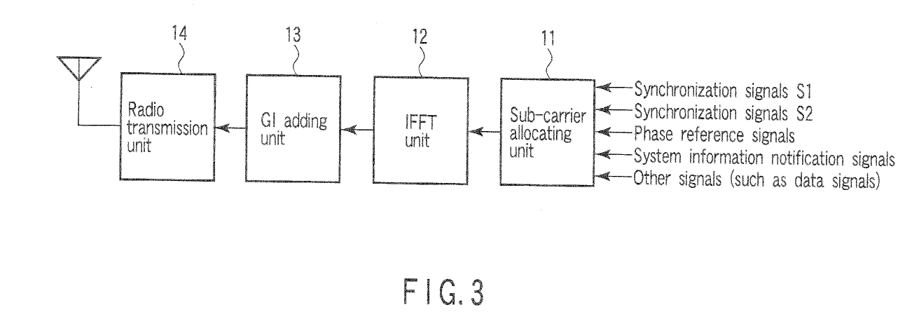

FIG. 3 shows the configuration of the transmitting system of the base station, which comprises a sub-carrier allocating unit 11, an IFFT (Inverse Fast Fourier Transform) unit 12, a GI (Guard Interval) adding unit 13, and a radio transmission unit 14. This figure shows the transmitting system alone, but the base station also comprises the configuration of the receiving system for receiving the radio signal from the mobile station.

The sub-carrier allocating unit 11 generates signals obtained by allocating the synchronization signals S1, the synchronization signals S2, the phase reference signals, the system information notification signals and the other signals (data signals and the like) to the sub-carriers, to generate the OFDM symbols located as shown in FIG. 1 by the IFFT unit 12 of the subsequent stage.

The format to which each signal is allocated by the sub-carrier allocating unit 11 is known to the mobile station. The synchronization signal S1 is allocated to the sub-carrier of a predetermined time-frame in the time cycle which is known to the mobile station, and is used to identify the frame in the time domain with the synchronization code known to the mobile station.

Similarly to the synchronization signals S1, the synchronization signals S2 are allocated to the sub-carriers of a predetermined time-frame in the time cycle known to the mobile station. The synchronization signals S2 include the synchronization code allocated to the group to which the base station serving as the transmitting station belongs.

The phase reference signals are signals of a pattern known to the mobile station, which are allocated at a location in the vicinity in time of the synchronization signals S2 and coded with a scrambling code allocated inherently to the base station serving as the transmitting station. The system information notification signals are data scrambled with the scrambling code allocated inherently to the base station serving as the transmitting station, and include the information required for demodulation of the data signals and the like.

The IFFT unit 12 executes OFDM (Orthogonal Frequency Division Multiplexing) modulation for the signals output from the sub-carrier allocating unit 11 and generates the OFDM signals in which the signals are located as shown in FIG. 1. In other words, the IFFT unit 12 generates the OFDM signals by converting the frequency-domain signals into the time-domain signals.

The GI adding unit 13 adds guard interval (GI) to the OFDM signals generated by the IFFT unit 12.

The radio transmission unit 14 comprises a digital-analog converter which converts the digital guard interval-added OFDM signals into analog signals, an up-converter which up-converts the analog signal thereby obtained to the radio frequency, and a power amplifier which amplifies the power of the radio (RF) signals thereby obtained. The radio signals output from the power amplifier are transmitted from the antenna.

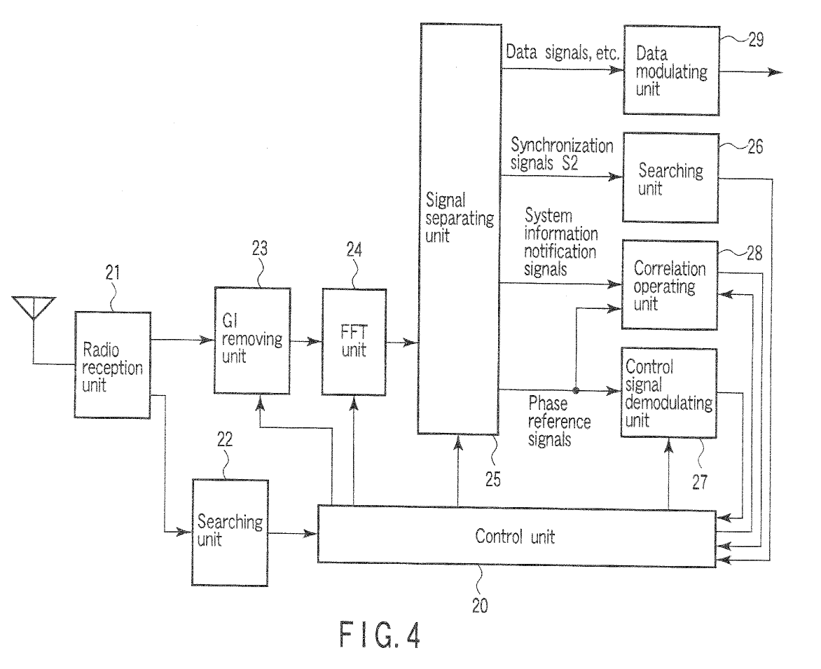

FIG. 4 shows the configuration of the receiving system of the mobile station, which comprises a radio reception unit 21, a searching unit 22, a GI (Guard Interval) removing unit 23, an FFT (Fast Fourier Transform) unit 24, a signal separating unit 25, a searching unit 26, a control signal demodulating unit 27, a correlation operating unit 28, and a data modulating unit 29. This figure shows the receiving system alone, but the mobile station also comprises a configuration of the transmitting system which transmits the radio signals to the base station.

The radio reception unit 21 comprises a band-pass filter which removes noise in a band other than the desired band from the radio signals received via the antenna, and an AD converter which converts the analog signals of the output of the band-pass filter into baseband digital signals.

The searching unit 22 executes the Process A of the above-explained initial synchronization process. The searching unit 22 detects a frame timing of removing the guard interval and the timing of cutting out the sampling data string by FFT (Fast Fourier Transform) operation by obtaining cross-correlation between the sampling data string of the baseband digital signals obtained by the radio reception unit 21 and the known synchronization code included in the synchronization signals S1, and notifies the control unit 20 of these timings.

The control unit 20 notified of these timings directs the GI removing unit 23 and the FFT unit 24 to execute their own processes, in accordance with the timings. In addition, the control unit 20 notifies the signal separating unit 25 of the locations of frequency and time of the signals allocated to the sub-carriers of the respective time frames, on the basis of the notified timing of the time frame.

The GI removing unit 23 removes the guard interval from the baseband digital signals output from the radio reception unit 21 at the frame timing directed by the control unit 20.

The FFT unit 24 converts the time-domain signals in the baseband signals having the guard interval removed, into the frequency-domain signals at the timing directed by the control unit 20 and divides the frequency-domain signals into signals for the respective sub-carriers.

The signal separating unit 25 is notified of the locations in time and frequency of the signals divided for the respective sub-carriers by the FFT unit 24. In accordance with the notification, the signal separating unit 25 outputs the synchronization signals S2 of the signals allocated to the respective sub-carriers to the searching unit 26, outputs the system information notification signals to the control signal demodulating unit 27, outputs the phase reference signals to the control signal demodulating unit 27 and the correlation operating unit 28, and outputs the other signals (data signals and the like) to the data modulating unit 29.

The searching unit 26 executes the Process B of the above-described initial synchronization process. The searching unit 26 detects the group of the base station serving as the transmitting station by obtaining the cross-correlation between the synchronization codes included in the synchronization signals S2 and the synchronization codes of a plurality of base station groups pre-stored, and notifies the control unit 20 of the group of the base station. The control unit 20 classifies a plurality of base stations into groups and stores the scrambling codes allocated inherently to the respective groups. If the control unit 20 receives the notification of the group, the control unit 20 notifies the control signal demodulating unit 27 of the base station ID belonging to the group.

The control signal demodulating unit 27 executes the Process C of the above-described initial synchronization process. The control signal demodulating unit 27 stores a table which associates all the base station ID of candidates with preliminarily allocated inherent scrambling codes. The control signal demodulating unit 27 obtains the cross-correlation between the scrambling codes corresponding to the base station ID notified by the control unit 20 and the phase reference signals output from the signal separating unit 25, detects the base station ID of the scrambling code from which the greatest correlation value can be obtained, and notifies the control unit 20 of the base station ID. The control signal demodulating unit 27 can further enhance the synchronization performance by executing a vector operation of the correlation value upon obtaining the cross-correlation.

When the control unit 20 receives the notification of the base station ID from the control signal demodulating unit 27, the control unit 20 detects the scrambling code corresponding to the base station ID by retrieving the table which associates the base station ID with the scrambling codes, and notifies the correlation operating unit 28 of the detected scrambling code.

The correlation operating unit 28 executes the Process D of the above-described initial synchronization process. The correlation operating unit 28 executes channel estimation of the sub-carrier frequencies to which the respective system information notification signals are allocated, on the basis of the scrambling code notified by the control unit 20 and the phase reference signals input from the signal separating unit 25, and executes channel equivalence of the system information notification signals input from the signal separating unit 25, on the basis of the estimation result. Then, the correlation operating unit 28 demodulates the channel-equivalent system information notification signals by using the scrambling code, regenerates the bit strings of the system information notification signals, and outputs the bit strings to the control unit 20.

The accuracy of the channel estimation can be enhanced by interpolation of averaging based on the sub-carriers of some phase reference signals that are proximate to the system information notification signals in the frequency direction in the same time.

When the control unit 20 inputs the bit strings of the system information notification signals regenerated by the correlation operating unit 28, the control unit 20 controls the data modulating unit 29 on the basis of the bit strings and urges the data modulating unit 29 to demodulate the signals such as the data signals and the like.

In the OFDM cellular system having the above-described configuration, the density of the phase reference signals of the time frame used in the initial synchronization process (time frame including the system information notification signals, or time frame in the vicinity thereof), in the channel band for initial synchronization, is more increased than that in the other time frames. Therefore, the stability of the initial synchronization process can be enhanced by the reduction in the detection time of the phase reference signals and the improvement in the demodulating performance of the control signal.

In addition, since the frequency band making the phase reference signals at high density is limited, the mobile station can stably achieve the synchronization performance and carry out the initial synchronization process by preliminarily recognizing the system band of the base station, and can thereby simplify the searching of the initial synchronization process. In addition, since the time symbol making the phase reference signals at high density is limited, the power consumption of the mobile station can be reduced by, for example, stopping the reception RF outside the time frame.

A circuit for compensating for the difference in clock frequency between the own station and the base station by feedback may be built in the mobile station.

In the above-described OFDM cellular system, since the system information notification signals need to be received in the initial synchronization process in which the compensation is not sufficiently converged, the correlation in the frequency direction becomes lowered due to the phase error, and the frequency section for interpolation and averaging becomes narrower upon obtaining the channel estimate value by the control signal demodulating unit 28, as compared with that after converging the frequency compensation.

In the OFDM cellular system having the above-described configuration, however, since the symbols of high power density in the frequency direction of the phase reference signals are located in the vicinity of the system information notification signals, the electric power of the phase reference signals can be sufficiently reserved and the channel estimate accuracy can be maintained.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

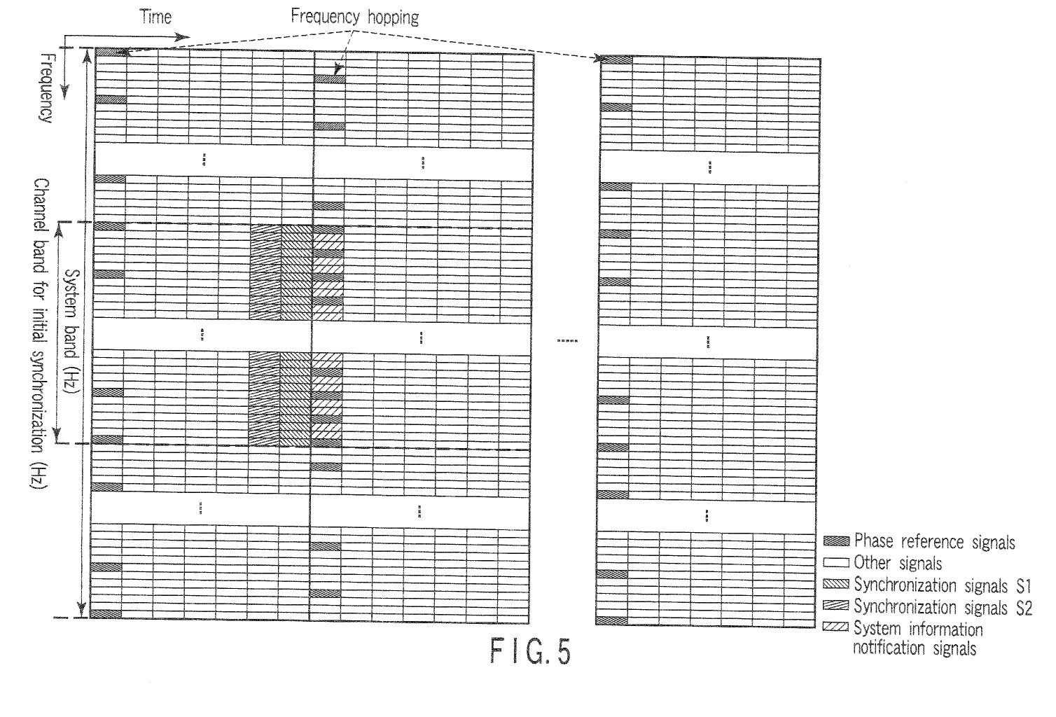

For example, if the frequency position of the phase reference signals in the channel band for initial synchronization is constant irrespective of the transmitting base station or the time frame as shown in FIG. 5 instead of FIG. 1, the present invention can be applied to a case where the frequency position of the phase reference signals in the other channel bands is shifted for each transmitting base station or each time frame. In this case, too, the mobile station can accomplish the initial synchronization process with a stable synchronization performance without being informed of the amount to be shifted, and the searching of the initial synchronization process can be simplified.

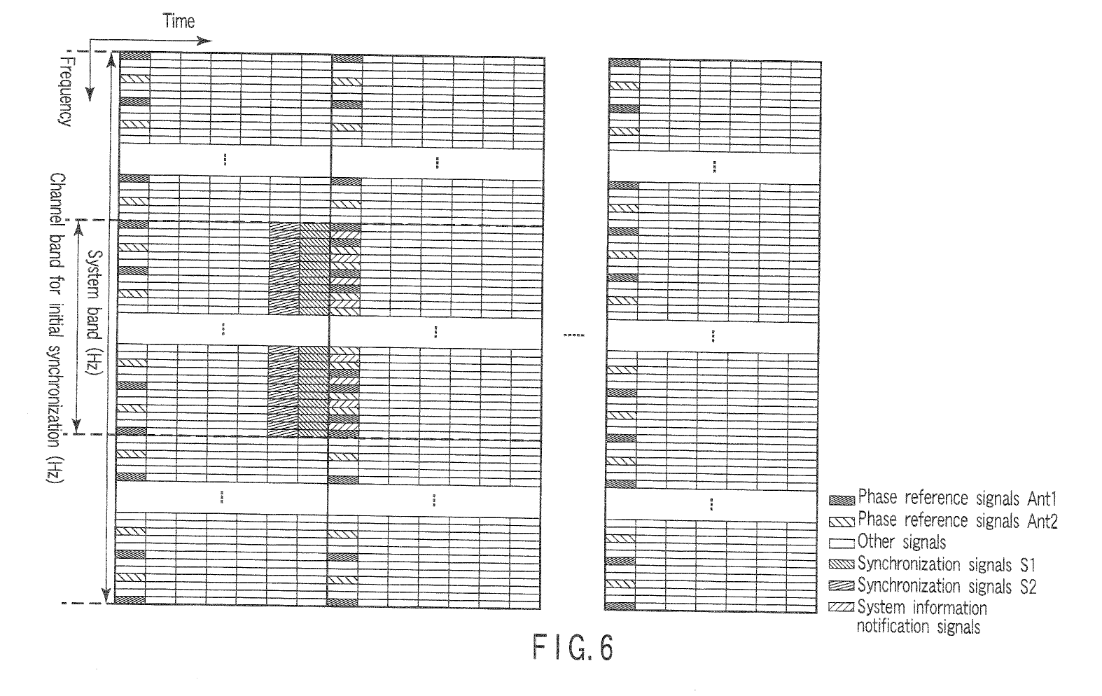

The present invention can also be applied to a case where the base station comprises a plurality of transmission antennas and the phase reference signals transmitted from the transmission antennas are subjected to OFDM (Orthogonal Frequency Division Multiplexing). An example of the application is shown in FIG. 6. In this example, the base station comprises two transmission antennas to transmit reference signal Ant1 or Ant2 corresponding to each of the transmission antennas. Even if the base station comprises a plurality of transmission antennas, the same process as that in a case where the base station comprises one transmission antenna can be applied by the number of the antennas.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An OFDM radio communication system comprising a plurality of transmitters transmitting OFDM signals and a receiver receiving the OFDM signals,
each of the transmitters comprising a transmitting unit which, of a preset first frequency band common to the plurality of transmitters and a second frequency band other than the first frequency band, allocates a phase reference signal in the first frequency band, at a higher power density than that in the second frequency band, and transmits the OFDM signal to which a control signal including system information that needs to be received prior to starting the transmission,
the receiver comprising:
a receiving unit which receives the OFDM signal transmitted from the transmitter; and
a demodulating unit which executes channel equivalence of the control signal and demodulates the control signal, in accordance with the phase reference signal received in the first frequency band by the receiving unit.

2. The OFDM radio communication system according to claim 1, wherein the transmitting unit allocates the phase reference signal to a time frame allocated to the control signal, in the first frequency band, at a higher power density than that in the second frequency band, and transmits the phase reference signal.

3. The OFDM radio communication system according to claim 1, wherein the transmitting unit allocates the phase reference signal to a sub-carrier in a vicinity of a sub-carrier to which the control signal is allocated, in the first frequency band, at a higher power density than that in the second frequency band, and transmits the phase reference signal.

4. The OFDM radio communication system according to claim 1, wherein the transmitting unit allocates the phase reference signal having a frequency varied for each transmitter or each time frame, to the second frequency band, and transmits the phase reference signal.

5. The OFDM radio communication system according to claim 1, wherein the transmitting unit transmits the phase reference signals subjected to frequency orthogonal multiplexing, via different antennas.

6. A radio communication method in an OFDM radio communication system comprising a plurality of transmitters transmitting OFDM signals and a receiver receiving the OFDM signals,
each of the transmitters comprising a transmitting step of, of a preset first frequency band common to the plurality of transmitters and a second frequency band other than the first frequency band, allocating a phase reference signal in the first frequency band, at a higher power density than that in the second frequency band, and transmitting the OFDM signal to which a control signal including system information that needs to be received prior to starting the transmission,
the receiver comprising:
a receiving step of receiving the OFDM signal transmitted from the transmitter; and
a demodulating unit which executes channel equivalence of the control signal and demodulates the control signal, in accordance with the phase reference signal received in the first frequency band in the receiving step.

7. The method according to claim 6, wherein the transmitting step allocates the phase reference signal to a time frame allocated to the control signal, in the first frequency band, at a higher power density than that in the second frequency band, and transmits the phase reference signal.

8. The method according to claim 6, wherein the transmitting step allocates the phase reference signal to a sub-carrier in a vicinity of a sub-carrier to which the control signal is allocated, in the first frequency band, at a higher power density than that in the second frequency band, and transmits the phase reference signal.

9. The method according to claim 6, wherein the transmitting step allocates the phase reference signal having a frequency varied for each transmitter or each time frame, to the second frequency band, and transmits the phase reference signal.

10. The method according to claim 6, wherein the transmitting step transmits the phase reference signals subjected to frequency orthogonal multiplexing, via different antennas.
